(19) United States
(12) Patent Application Publication
(10) Pub. No.: US 2012/0268226 A1
(43) Pub. Date: Oct. 25, 2012

(54) MAGNETIC PARTICLE, HIGH FREQUENCY MAGNETIC MATERIAL AND HIGH FREQUENCY DEVICE

(75) Inventors: Akira Nakamura, Ebina-shi (JP); Miyuki Eda, Sagamihara-shi (JP)

(73) Assignee: Mitsumi Electric Co., Ltd., Tokyo (JP)

(21) Appl. No.: 13/448,616

(22) Filed: Apr. 17, 2012

(30) Foreign Application Priority Data
Apr. 25, 2011 (JP) 2011-09 69 97

(51) Int. Cl. H01F 7/02

(52) U.S. Cl. 335/302

(57) ABSTRACT

A magnetic particle includes a metallic magnetic and a coating film. The coating film includes an oxide, a nitride, a carbide or a fluoride, and covers the metallic magnetic. Hydrophobic treatment using a hydrophobing agent is carried out on the magnetic particle.

### BACKGROUND OF THE INVENTION

1. Field of the Invention

The present invention relates to a magnetic particle, a high frequency magnetic material and a high frequency device.

2. Description of the Related Art

Conventionally, magnetic materials are used for various magnetic applied products. Among the magnetic materials, materials, the magnetization of which is largely changed in a weak magnetic field, are referred to as soft magnetic materials.

The soft magnetic materials are classified by material type into metallic materials, amorphous materials and oxide materials. Among the soft magnetic materials, the oxide materials (ferrite materials) which have high resistivity and can lower eddy current loss are used at a high frequency of 1 MHz or more. For example, a Ni—Zn ferrite material is known as a ferrite material used at the high frequency.

With respect to the soft magnetic materials including the ferrite materials, at a high frequency of around 1 GHz, the real part Re(μ) of the complex magnetic permeability is decreased, and the imaginary part Im(μ) thereof is increased, with magnetic resonance. The imaginary part Im(μ) of the complex magnetic permeability is a term showing magnetic energy loss. Hence, the imaginary part Im(μ) thereof being a high value is not preferable in practical use, for example, in a case where a soft magnetic material is applied to a magnetic core or an antenna.

On the other hand, the real part Re(μ) thereof shows magnitude of a magnetic flux concentration effect or a wavelength shortening effect on electromagnetic waves. Hence, the real part Re(μ) thereof being a high value is preferable in practical use.

As an indicator to show energy loss of a magnetic material (magnetic loss), tangent delta (tan δ) expressed by the following first formula may be used.

tan δ=Im(μ)/Re(μ) [First Formula]

When the tangent delta is a large value, magnetic energy is converted into heat energy in a magnetic material, and transmission efficiency of necessary energy is decreased. Hence, it is preferable that tangent delta be a small value. In the following, magnetic loss is described as tangent delta (tan δ). When an alternating field H is impressed, the energy loss per unit volume is expressed by P=½·ωμoRe(μ)tan δ·H² (ω: angular frequency).

The soft magnetic materials include a thin-film material having low tan δ even in a high frequency band (a GHz band). For example, the thin-film material is an Fe-based soft magnetic thin film with high electrical resistivity or a Co-group thin film with high electrical resistivity. However, the volume of a thin film is small, and hence its application range is limited. In addition, a process of creating a thin film is complicated, and it requires expensive facility.

In order to solve such problems, a resin molding technology is applied to a composite magnetic material in which a magnetic material is dispersed in resin. For example, Japanese Patent Application Laid-Open Publication No. hei 11-354973 describes a technology which provides an electromagnetic wave absorber having an excellent radio wave absorbing property in a broadband by combining powder of a nanocrystal soft magnetic material with resin.

Furthermore, Japanese Patent Application Laid-Open Publication No. 2008-069381 describes a flat soft magnetic metal particle which gives magnetism to a non-magnetic material by dispersing the soft magnetic metal particle as filler in the non-magnetic material such as resin.

There has been a request to reduce magnetic loss (tan δ) and energy loss of a dielectric (dielectric loss) in a high frequency band (MHz-GHz band) as properties which an excellent magnetic material should have.

### SUMMARY OF THE INVENTION

Object of the present invention is to provide a magnetic particle, a high frequency magnetic material and a high frequency device to reduce magnetic loss and dielectric loss in the high frequency band.

In order to achieve at least one object described above, according to a first aspect of the present invention, there is provided a magnetic particle including: a metallic magnetic; and a coating film including an oxide, a nitride, a carbide or a fluoride, the coating film covering the metallic magnetic, wherein hydrophobic treatment using a hydrophobing agent is carried out on the magnetic particle.

In order to achieve at least one object described above, according to a second aspect of the present invention, there is provided a high frequency magnetic material including: the magnetic particle; and thermoplastic resin combined with the magnetic particle.

In order to achieve at least one object described above, according to a third aspect of the present invention, there is provided a high frequency device including: at least one of an antenna, an inductor and a circuit substrate, each of which includes the high frequency magnetic material.

### BRIEF DESCRIPTION OF THE DRAWING

The present invention will be fully understood by the following detailed description and the accompanying drawings, which are not intended to limit the present invention, wherein:

FIG. 1 schematically shows a structure of a magnetic particle in accordance with an embodiment of the present invention;

FIG. 2 shows a TEM (Transmission Electron Microscope) image of the magnetic particle;

FIG. 3A shows a particle image of the magnetic particle with FESEM (Field Emission-Scanning Electron Microscope)—EDX (Energy Dispersive X-ray spectrometry);

FIG. 3B shows element distribution of oxygen in the particle image of the magnetic particle shown in FIG. 3A;

FIG. 4A shows a first antenna to which a high frequency magnetic material is applied;

FIG. 4B shows a second antenna to which the high frequency magnetic material is applied;

FIG. 4C shows a third antenna to which the high frequency magnetic material is applied;

FIG. 4D shows a fourth antenna to which the high frequency magnetic material is applied;

FIG. 5 shows a fifth antenna to which the high frequency magnetic material is applied;

FIG. 6 shows an inductor to which the high frequency magnetic material is applied; and

FIG. 7 shows a circuit substrate to which the high frequency magnetic material is applied.

### DETAILED DESCRIPTION OF THE PREFERRED EMBODIMENT

In the following, an embodiment of the present invention is described in detail with reference to the accompanying drawings. However, the present invention is not limited to the embodiment or drawings.

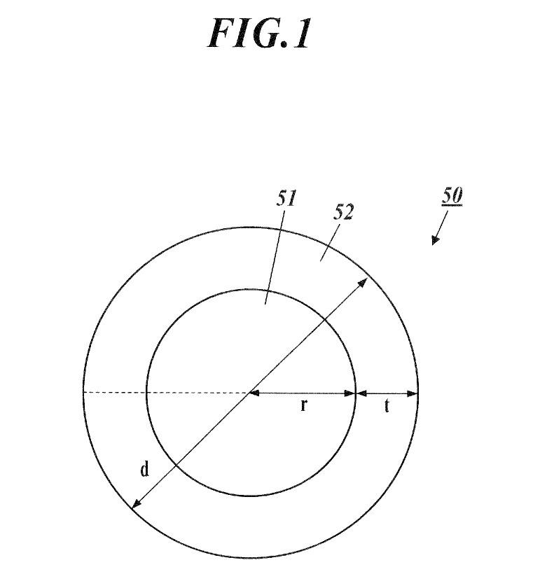

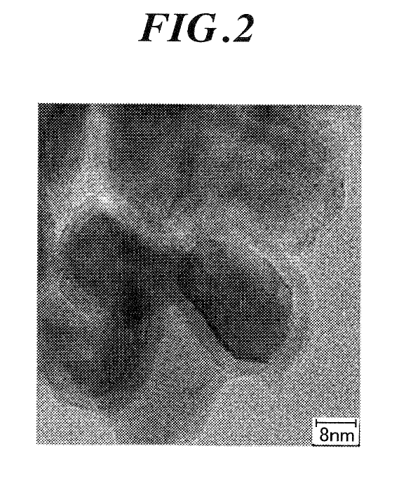

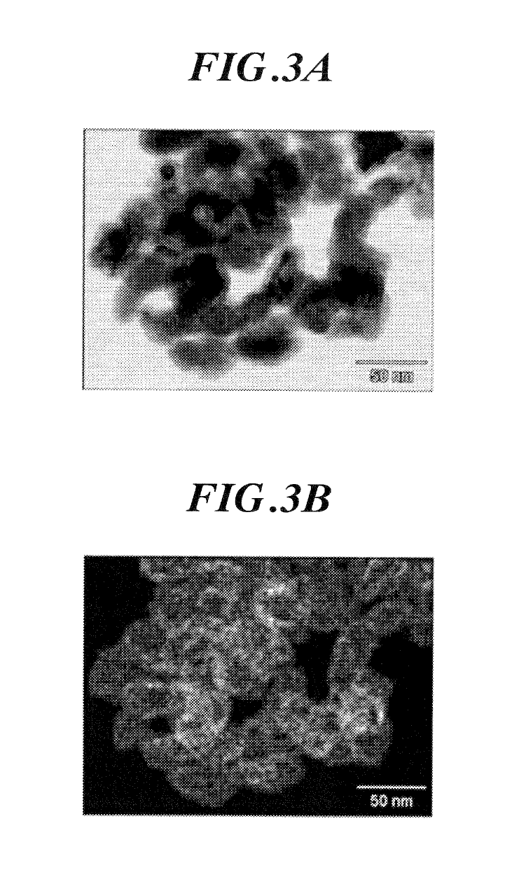

The embodiment of the present invention is described with reference to FIGS. 1 to 7. First, with reference to FIGS. 1 to 3, characteristics of a magnetic particle 50 in the embodiment are described. FIG. 1 schematically shows a structure of the magnetic particle 50 in the embodiment. FIG. 2 shows a TEM image of the magnetic particle 50. FIG. 3A shows a particle image of the magnetic particle 50 with FESEM-EDX. FIG. 3B shows element distribution of oxygen in the particle image of the magnetic particle 50 with FESEM-EDX shown in FIG. 3A.

As shown in FIG. 1, the magnetic particle 50 in the embodiment is constituted of a metallic magnetic 51 and a coating film 52. In FIG. 1, the metallic magnetic 51 is spherical, and the coating film 52 coats the metallic magnetic 51 with a fixed thickness, so that the magnetic particle 50 is spherical schematically. In fact, as shown in FIG. 2, the magnetic particle 50 and the metallic magnetic 51 are not completely spherical. In FIG. 2, the dark part is the metallic magnetic 51, and the light part around the dark part is the coating film 52. The scale of FIG. 2 is 8 nm.

The metallic magnetic 51 is constituted of a plurality of metals including at least iron (Fe). The other metals are, for example, aluminum (Al), cobalt (Co) and the like. However, among the plurality of metals of the metallic magnetic 51, Fe is the highest in weight ratio.

The coating film 52 is magnetite (Fe₃O₄) as an oxide. Fe₃O₄ has higher specific resistance (resistivity) than the metallic magnetic 51, and can reduce eddy current loss and dielectric loss. In addition, because Fe₃O₄ has excellent chemical stability, the metallic magnetic 51 can be prevented from oxidizing in a manufacturing process, and accordingly, long term reliability of the magnetic particle 50 can be improved.

The metallic magnetic 51 is manufactured using a liquid-phase method. The liquid-phase method is a method to make a compound (metallic magnetic 51) by dissolving a material (of the metallic magnetic 51) in a solvent so as to react the material with the solvent in a solution phase. Alternatively, it is possible, in a similar way, first, to make a precursor including a constituent element of the metallic magnetic 51 in a solution, and then, to convert the precursor to the metallic magnetic 51 by heating processing in a reducing atmosphere. The coating film 52 is formed by performing oxidation processing on the metallic magnetic 51. The oxidation processing is, for example, natural oxidation processing by which oxygen gas is transmitted to the metallic magnetic 51 so as to make the metallic magnetic 51 react with the oxygen gas automatically.

Now, values related to the shape of the magnetic particle 50 are described. More specifically, the specific surface area S (nm) of the magnetic particle 50, the particle diameter (diameter) d (nm) of the magnetic particle 50 and the thickness t (nm) of the coating film 52 are found.

As a microstructure model of the magnetic particle 50, the TEM image shown in FIG. 2 is observed. Based on the observation result, the metallic magnetic 51 is Fe, and the coating film 52 is Fe₃O₄. The density ρ of Fe is 7.87 (g/cm³), and the density ρ of Fe₃O₄ is 5.24 (g/cm³).

The outer surface of the magnetic particle 50 is black. Hence, it is reasonable to think that the coating film 52 is Fe₃O₄. The contents of the other elements, namely non-magnetic metallic elements, in the magnetic particle 50 are very small, and hence ignored here.

By FESEM-EDX, the element distribution of oxygen shown in FIG. 3B is obtained in the particle image of the magnetic particle 50 shown in FIG. 3A. The dark part in FIG. 3A is the magnetic particle 50. In FIG. 3B, the lighter (whiter) it is, the more oxygen exists. According to FIG. 3B, it is confirmed that more oxygen exists near the surface of the magnetic particle 50, and the surface of the metallic magnetic 51 is covered with the coating film 52. The scale of FIGS. 3A and 3B is 50 nm.

The specific surface area S and the particle diameter (diameter) d of the spherical magnetic particle 50 shown in FIG. 1 satisfy the following second formula.

$$d = \frac{6}{ρ \cdot S} \qquad [ Second Formula ]$$

Note that the “ρ” in the second formula is the density of the magnetic particle 50.

Hence, it is necessary that the density ρ substituted in the second formula be the average density ρ′ determined by the ratio of Fe to Fe₃O₄. The average density ρ′ is expressed by the following third formula.

$${ρ}^{′} = \frac{a + 1}{\frac{a}{{ρ}_{Fe}} + \frac{1}{{ρ}_{{Fe}_{3} {O}_{4}}}} \qquad [ Third Formula ]$$

Note that the “a” represents the mass ratio of Fe to Fe₃O₄, the “ρ_{Fe}” represents the density of Fe, and the “ρ_{Fe3O4}” represents the density of Fe₃O₄.

The mass ratio x of Fe to O is calculated by using the following fourth formula.

$$x = \frac{a + \frac{3 {M}_{Fe}}{3 {M}_{Fe} + 4 {M}_{O}}}{\frac{4 {M}_{O}}{3 {M}_{Fe} + 4 {M}_{O}}} \qquad [ Fourth Formula ]$$

Note that the “M_{Fe}” represents the atomic weight of Fe, and the “Mₒ” represents the atomic weight of O.

By making the “a” the subject of the fourth formula, the “a” is expressed by the following fifth formula, whereby the mass ratio a of Fe to Fe₃O₄ is found.

$$a = \frac{4 {M}_{O}}{3 {M}_{Fe} + 4 {M}_{O}} \cdot x - \frac{3 {M}_{Fe}}{3 {M}_{Fe} + 4 {M}_{O}} \qquad [ Fifth Formula ]$$

The particle diameter d is found by substituting the third formula and the fifth formula into the second formula. For the specific surface area S, a measurement value by BET (Brunauer, Emmett and Teller) method is used, and for the mass ratio x of Fe to O, a measurement value by SEM-EDX is used.

With reference to FIG. 1, a relation expressed by the following sixth formula is true.

d=2(r+t) [Sixth Formula]

The volume ratio of the coating film 52 to the metallic magnetic 51 is expressed by the following seventh formula.

$$a \cdot \frac{{ρ}_{{Fe}_{3} {O}_{4}}}{{ρ}_{Fe}} = \frac{\frac{4 π {r}^{3}}{3}}{\frac{4 {π ( r + t )}^{3}}{3} - \frac{4 π {r}^{3}}{3}} \qquad [ Seventh Formula ]$$

The thickness t of the coating film 52 is found by using the sixth formula and the seventh formula.

The particle diameter d and the thickness t may be found by directly measuring the TEM image of the magnetic particle 50 shown in FIG. 2.

Hydrophobic treatment is carried out on the magnetic particle 50 having the above characteristics. The hydrophobic treatment carried out on the magnetic particle 50 is described. The hydrophobic treatment is treatment to increase hydrophobicity of a minute particle (magnetic particle 50) by carrying out surface treatment on the minute particle with a coupling agent as a hydrophobing agent (surface treatment agent), so as to adhere the coupling agent to the minute particle.

For the hydrophobic treatment, there are a dry method such as a spray method, and a wet method such as a dip/soak method or a slurry method. The spray method is a method by which a diluted solution in which a coupling agent is diluted with water, alcohol or another solution is sprayed to powder of a minute particle being stirred. The dip/soak method is a method by which a minute particle is dipped/soaked in a coupling agent, and dried. The slurry method is a method by which a minute particle is put into a coupling agent so as to be slurry, and dried.

The coupling agent for the hydrophobic treatment is a titanium (Ti), silane or zirconium-based coupling agent. The titanium-based coupling agent is a coupling agent having Ti, such as isopropyl triisostearoyl titanate, isopropyl tri(dodecyl)benzenesulfonyl titanate, isopropyl tris(dioctyl pyrophosphate) titanate, tetraisopropylbis(dioctylphosphite) titanate, tetraoctylbis(ditridecylphosphite)titanate, tetra(2,2-diallyloxymethyl-1-butyl)bis (ditridecyl)phosphite titanate, bis(dioctyl pyrophosphate)oxyacetate titanate, bis(dioctyl pyrophosphate) ethylene titanate, isopropyl trioctanoyl titanate, isopropyl dimethacryl isostearoyl titanate, isopropyl isostearoyl diacryl titanate, isopropyl tri(dioctyl phosphate) titanate, isopropyl tricumylphenyl titanate, isopropyl tri(N-amidoethyl-aminoethyl)titanate, dicumylphenyloxyacetate titanate or diisostearoylethylene titanate.

The silane-based coupling agent is basically a coupling agent having a chemical structure of R—Si—(OX)₃. The “R” is a chemical group having a strong affinity for a party of a substance to be treated (minute particle). The “(OX)” is a methoxy group of —OCH₃, an ethoxy group of —OC₂H₅ or the like.

The zirconium-based coupling agent is a coupling agent, the principle metal of which is quadrivalent zirconium (Zr), such as Zirconium IV,2,2(bis-2-propenolatomethyl)butanolato, trisneodecanolato-O; Zirconium IV,2,2-bis(2-propenyloxymethyl)butanolato, tris(dodecylbenzenesulfonato-O)—; Zirconium IV,2,2(bis-2-propenplatomethyl)butanolato, tris(dioctyl)phosphato-O; Zirconium IV,2,2(bis-2-propenplatomethyl)butanolato, tris 2-methyl-2-propenoato-O; Zirconium IV,2,2(bis-2-propenolatomethyl)butanolato, bis(para amino benzoato-O); neopenthyl(diallyl)oxy, tri(dioctyl)pyrophosphato zirconate[Zirconium IV,2,2(bis 2-propenolatomethyl)butanolato, tris(diisoctyl)pyrophosphato-O]; Neopenthyl(diallyl)oxy, triacryl zirconate[Zirconium IV,2,2(bis 2-propenolatomethyl)butanolato, tris 2-propenoateo-O]; or Zirconium IV,2,2(bis-2-propenolatomethyl)butanolato, tris(2-ethylenediamino)ethylato.

With respect to the hydrophobic treatment, a hydrophobization degree (m value) is measured as a value directly evaluating hydrophobicity of powder of the magnetic particle 50. The hydrophobization degree (m value) is a methanol concentration shown by percentage at a certain point. The methanol concentration at the certain point is obtained as follows. With a powder wettability tester, the magnetic particle 50 is injected into a starting solvent of pure water, and methanol is added to the solution of the magnetic particle 50 and the pure water at 3 ml/min while the solution is stirred. When the transmitted light intensity of the solution is decreased to 90% of the initial transmitted light intensity thereof, the methanol concentration (%) of the solution is measured. This methanol concentration is defined as the hydrophobization degree (%). With this method, the measurement time is a few seconds. Hence, even under the gravity, when the affinity of the solvent for the magnetic particle 50 is small, the magnetic particle 50 does not precipitate out. Accordingly, the hydrophobicity can be evaluated by the polarity of the solution.

By using the magnetic particle 50 undergoing the hydrophobic treatment, a high frequency magnetic material (high frequency magnetic member) is created. The high frequency is a frequency band of UHF-GHz, and the high frequency magnetic material is suitable for a range of frequencies from 200 MHz to 3 GHz. In particular, the material is most suitable for the range thereof from 700 MHz to 1 GHz.

The high frequency magnetic material is a composite material created by mixing (kneading) the magnetic particle 50 with thermoplastic resin by heat with a twin screw extruder so as to be combined. As the thermoplastic resin, polypropylene (PP) or cycloolefin polymer (COP) is used.

Next, a proper structure of the high frequency magnetic material, in which the magnetic particle 50 undergoing the hydrophobic treatment and the thermoplastic resin are combined, and a magnetic property thereof are described.

First, as shown in the following Table 1, a plurality of sheet-shaped samples of the high frequency magnetic material was created. Each of the sheet-shaped samples had a width of 27 mm and a thickness of 1 mm. The samples were created by changing the elemental composition (wt %), the specific surface area S (cm²/g) and the particle diameter d (nm) of the magnetic particle 50, which has undergone the hydrophobic treatment, the thickness t (nm) of the coating film 52, the kind of the thermoplastic resin, and the filling rate (vol %) of the magnetic particle 50 in the high frequency magnetic material, and mixing the magnetic particle 50 with the thermoplastic resin by heat with a twin screw extruder so as to be molded into the shape of a sheet.

TABLE 1

| | | | | | | SPECIFIC | | | | | |
|---|---|---|---|---|---|---|---|---|---|---|---|
| | COMPOSITION | | | | | SURFACE | PARTICLE | | | FILLING | |
| | [wt %] | | | | | AREA | DIAMETER | THICKNESS | | RATE | tan δ |
| | Fe | Co | Al | O | OTHERS | S [cm²/g] | d [nm] | t [nm] | RESIN | [vol %] | [700 MHz] |
| SAMPLE | 66.9 | 0 | 2.3 | 14.6 | 16.3 | 31 | 33 | 5.8 | COP | 20 | 0.007 |
| EXAMPLE 1 | | | | | | | | | | | |
| SAMPLE | 80.6 | 0 | 1.0 | 10.9 | 7.5 | 26 | 36 | 4.0 | COP | 20 | 0.005 |
| EXAMPLE 2 | | | | | | | | | | | |
| SAMPLE | 80.5 | 0 | 1.5 | 8.7 | 9.4 | 25 | 36 | 3.2 | COP | 20 | 0.006 |
| EXAMPLE 3 | | | | | | | | | | | |
| SAMPLE | 77.5 | 0 | 1.6 | 9.5 | 11.4 | 28 | 33 | 3.3 | COP | 20 | 0.012 |
| EXAMPLE 4 | | | | | | | | | | | |
| SAMPLE | 60.2 | 6.4 | 4.9 | 20.6 | 8.0 | 62 | 18 | 4.7 | PP | 20 | 0.010 |
| EXAMPLE 5 | | | | | | | | | | | |
| SAMPLE | 67.6 | 2.6 | 2.2 | 15.9 | 11.7 | 46 | 22 | 4.1 | PP | 20 | 0.005 |
| EXAMPLE 6 | | | | | | | | | | | |
| COMPARATIVE | 76.7 | 0 | 0.5 | 5.6 | 17.3 | 18 | 48 | 3.0 | COP | 20 | 0.022 |
| EXAMPLE 1 | | | | | | | | | | | |

Then, the sheet-shaped samples were mechanically processed to be in the shape of a plate of 4×4×0.7 mmt, whereby sample examples 1 to 6 of the high frequency magnetic material in accordance with the embodiment and a comparative example 1 were created. In order to evaluate the magnetic loss (tan δ) as the magnetic property, tan δ of the sample examples 1 to 6 and the comparative example 1 were measured at 700 MHz with a UHF band magnetic permeability measuring device. The specific surface area S, the particle diameter d and the thickness t shown in Table 1 were calculated by using the second to seventh formulas.

According to Table 1, when the particle diameter d is 45 nm or less, small tan δ can be obtained. It is preferable that the particle diameter d be 10 nm to 36 nm. As for the thickness t, when the thickness t is 1 nm to 10 nm, oxidation or ignition does not occur in the mixing process, and small tan δ and excellent reproducibility can be obtained. It is preferable that the thickness t be 3 nm to 6 nm.

In view of the magnetic loss, it is preferable that the particle diameter d be small so as to reduce eddy current loss. On the other hand, when the particle diameter d is too small, a peculiar magnetized state such as a single domain state or a superparamagnetic state occurs. Hence, a too-small particle diameter d is not preferable. According to the micro-magnetic simulation by the inventors of the present invention, it has been confirmed that Fe isolatedly existing has a single domain structure when the particle diameter d is 20 nm. However, according to the sample examples 1 to 6, even when the particle diameter d is small, because of interaction among the magnetic particle 50 (i.e. between magnetic particles 50) or magnetic anisotropy of the surface, there is no notable property degradation. In the sample example 5, although the particle diameter of the metallic magnetic 51 is 8.6 nm (diameter d−thickness t×2=18−4.7×2=8.6 nm), an excellent magnetic property is obtained.

The magnetic property as the high frequency magnetic material is obtained by appropriately selecting values in accordance with a product design (design of a magnetic applied product), and selecting a proper filling rate. It is preferable that the magnetic permeability (the real part Re(μ) of the complex magnetic permeability) of the high frequency magnetic material be high. Accordingly, when the high frequency magnetic material is applied to an antenna, the antenna can be miniaturized through the wavelength shortening effect. Also, when the high frequency magnetic material is applied to an inductor, an inductance value (L) can be made high. On the other hand, if a too-high filling rate is selected, the mixability and the moldability decrease, and the energy loss caused by the magnetic loss (tan δ) increases. Consequently, product characteristics deteriorate. That is, it is not preferable to make the filling rate too high. It is preferable that the filling rate be 1 vol % to 60 vol %, in particular, 10 vol % to 40 vol %.

Next, effects of the hydrophobic treatment carried out on the magnetic particle 50 included in the high frequency magnetic material are described. First, the hydrophobic treatment was carried out on the magnetic particle 50 under the conditions shown in the following Table 2. The magnetic particle 50 had the structure of the sample example 2 shown in Table 1 prior to the hydrophobic treatment.

TABLE 2

| | HYDROPHOBING | | | |
|---|---|---|---|---|
| | AGENT | HYDROPHOBIZATION | DIELECTRIC | |
| | CONCENTRATION | DEGREE | LOSS | SHEAR VISCOSITY |
| | [wt %] | m[%] | [tan δ] | [Pa · s] |
| SAMPLE | 2 | 54 | 0.059 | 278.7 |
| EXAMPLE 7 | | | | |
| SAMPLE | 7 | 58 | 0.032 | 110.4 |
| EXAMPLE 8 | | | | |
| SAMPLE | 15 | NOT MEASURED | 0.040 | 148.7 |
| EXAMPLE 9 | | | | |
| COMPARATIVE | 0 | 0 | 0.25 | NOT MEASURED |
| EXAMPLE 2 | | | | |

The hydrophobic treatment was carried out by a wet method (a slurry method), using a titanium-based coupling agent as a hydrophobing agent, and using toluene as a solvent. A plurality of sheet-shaped samples of the high frequency magnetic material was created. Each of the sheet-shaped samples thereof had a width of 27 mm and a thickness of 1 mm. The sheet-shaped samples thereof were created by mixing the magnetic particle 50, which had undergone the hydrophobic treatment with the hydrophobing agent having a different concentration, with PP as the thermoplastic resin by heat with a twin screw extruder so as to be molded into the shape of a sheet. The filling rate of the magnetic particle 50 in the high frequency magnetic material was 20 vol % to 31.6 vol %. Each of the sheet-shaped samples was mechanically processed to be in the shape of a rectangle (a strip of paper) of 3×70×0.5 mmt. As a result, sample examples 7 to 9 of the high frequency magnetic material in accordance with the embodiment and a comparative example 2 were created. The hydrophobic treatment had not been carried out on the magnetic particle 50 of the comparative example 2.

In order to evaluate the hydrophobicity of the magnetic particle 50, the hydrophobization degree (m value) shown by percentage obtained by the hydrophobic treatment was measured by the above-described measurement method.

Then, the dielectric loss (tan δ) of the sample examples 7 to 9 and the comparative example 2 was evaluated at a measurement frequency of 1 GHz, using a cavity resonator. When the complex permittivity is expressed by ∈=Re(∈)−j·Im(∈), the dielectric loss (tan δ) is defined by Im(∈)/Re(∈). The dielectric loss (tan δ) is a value related to the energy loss caused by a dielectric material. The energy loss per unit volume at the time when an AC electric field E is impressed is expressed by P=½·ω∈oRe (∈)tan δ·E² (ω: angular frequency).

In addition, shear viscosity of the sample examples 7 to and the comparative example 2 was measured, using a capirograph, with shear velocity being 1216 (1/s).

According to Table 2, the dielectric loss of the sample examples 7 to 9, the magnetic particle 50 of which had undergone the hydrophobic treatment, was lower than that of the comparative example 2. This is because wettability of the magnetic particle 50 and the thermoplastic resin was increased by the hydrophobic treatment, shear heat generation in the mixing was suppressed, and deterioration of the thermoplastic resin by heat was suppressed. In order to obtain the effect, it is necessary that the hydrophobization degree of the magnetic particle 50 is 50% or more.

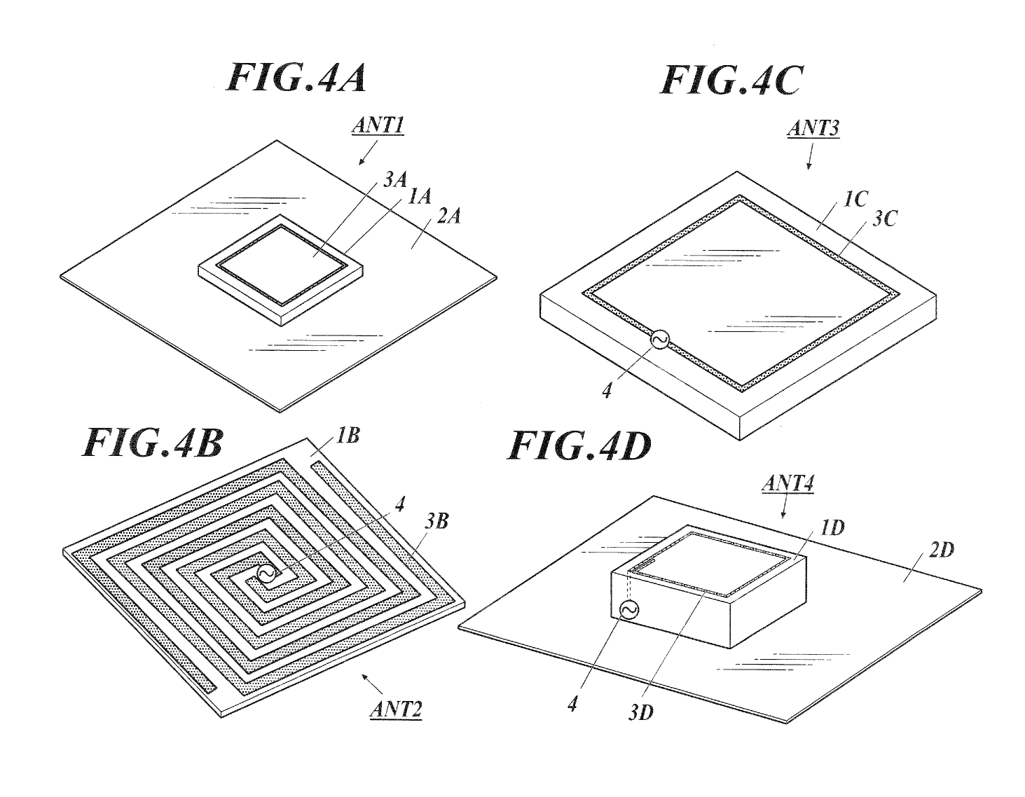

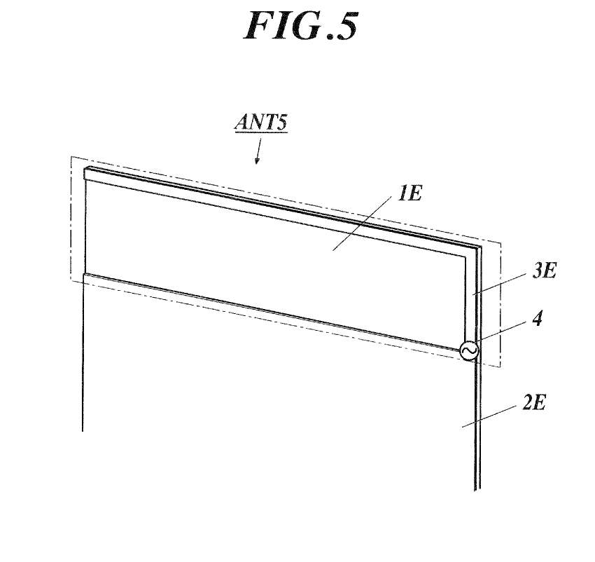

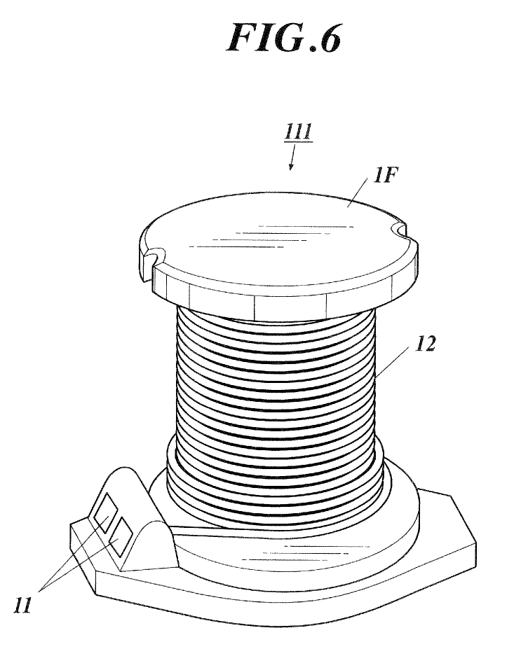

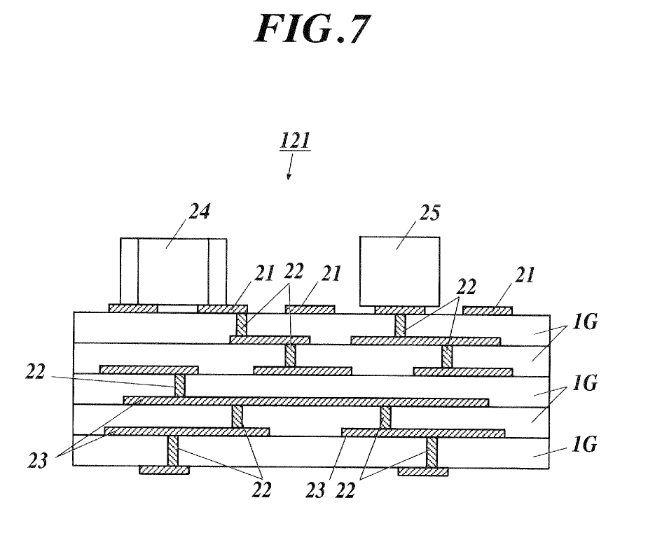

With reference to FIGS. 4A to 7, cases are described, the cases where the high frequency magnetic material in which the magnetic particle 50 undergoing the hydrophobic treatment and the thermoplastic resin are combined is applied to a high frequency device (an antenna, an inductor or a circuit substrate). FIG. 4A shows an antenna ANT1 to which the high frequency magnetic material is applied. FIG. 4B shows an antenna ANT2 to which the high frequency magnetic material is applied. FIG. 4C shows an antenna ANT3 to which the high frequency magnetic material is applied. FIG. 4D shows an antenna ANT4 to which the high frequency magnetic material is applied. FIG. 5 shows an antenna ANT5 to which the high frequency magnetic material is applied. FIG. 6 shows an inductor 111 to which the high frequency magnetic material is applied. FIG. 7 shows a circuit substrate 121 to which the high frequency magnetic material is applied.

With reference to FIGS. 4A to 5, the antennas are described, the antennas to each of which the high frequency magnetic material in which the magnetic particle 50 undergoing the hydrophobic treatment and the thermoplastic resin are combined is applied. The antenna ANT1 shown in FIG. 4A includes: a high frequency magnetic material 1A in which the magnetic particle 50 undergoing the hydrophobic treatment and the thermoplastic resin are combined; a ground plate 2A; and an electrode 3A. In the antenna ANT1, the high frequency magnetic material 1A is formed on the ground plate 2A, and the electrode 3A is formed on the high frequency magnetic material 1A.

The antenna ANT2 shown in FIG. 4B includes: a high frequency magnetic material 1B in which the magnetic particle 50 undergoing the hydrophobic treatment and the thermoplastic resin are combined; an electrode 3B; and a feeding point 4. The feeding point 4 is a feeding point of an antenna current. (The feeding points 4 shown in FIGS. 4C, 4D and 5 are also feeding points of antenna currents.) In the antenna ANT2, the electrode 3B is formed on the high frequency magnetic material 1B. The electrode 3B may be incorporated into the high frequency magnetic material 1B.

The antenna ANT3 shown in FIG. 4C includes: a high frequency magnetic material 1C in which the magnetic particle 50 undergoing the hydrophobic treatment and the thermoplastic resin are combined; an electrode 3C; and the feeding point 4. The electrode 3C may be disposed inside the high frequency magnetic material 1C.

The antenna ANT4 shown in FIG. 4D includes: a high frequency magnetic material 1D in which the magnetic particle 50 undergoing the hydrophobic treatment and the thermoplastic resin are combined; a ground plate 2D; an electrode 3D; and the feeding point 4. In the antenna ANT4, the high frequency magnetic material 1D is formed on the ground plate 2D, and the electrode 3D is incorporated into the high frequency magnetic material 1D. The electrode 3D may be disposed inside the high frequency magnetic material 1D.

The antenna ANT5 shown in FIG. 5 includes: a high frequency magnetic material 1E in which the magnetic particle 50 undergoing the hydrophobic treatment and the thermoplastic resin are combined; a ground plate 2E; and an electrode 3E. In the antenna ANT5, the high frequency magnetic material 1E is formed in such a way that at least one face thereof is level with a face of the ground plate 2E, and the electrode 3E is formed on the high frequency magnetic material 1E.

The inductor 111 shown in FIG. 6 includes: a high frequency magnetic material 1F in which the magnetic particle 50 undergoing the hydrophobic treatment and the thermoplastic resin are combined; terminals 11; and a winding 12. The high frequency magnetic material 1F is applied to the inductor 111 so as to obtain that structure.

The circuit substrate 121 shown in FIG. 7 includes: a high frequency magnetic material 1G in which the magnetic particle 50 undergoing the hydrophobic treatment and the thermoplastic resin are combined; lands 21; via holes 22; inner electrodes 23; and surface mounted components 24 and 25. In the circuit substrate 121 shown in FIG. 7, the high frequency magnetic material 1G is used for all layers. However, the high frequency magnetic material 1G may be used for one layer at least. The high frequency magnetic material 1G is applied to the circuit substrate 121 so as to obtain that structure.

As described above, in the embodiment, the magnetic particle 50 includes the metallic magnetic 51 and the coating film 52 of an oxide coating the circumference of the metallic magnetic 51, and undergoes the hydrophobic treatment using a hydrophobing agent. In the high frequency magnetic material, the magnetic particle 50 undergoing the hydrophobic treatment and the thermoplastic resin are combined. Accordingly, with the high frequency magnetic material including the magnetic particle 50 undergoing the hydrophobic treatment, the magnetic loss and the dielectric loss at the high frequency can be reduced.

Furthermore, the hydrophobization degree of the magnetic particle 50 is 50% or more. Accordingly, with the high frequency magnetic material including the magnetic particle 50 undergoing the hydrophobic treatment, the dielectric loss at the high frequency can be further reduced.

Furthermore, the metallic magnetic 51 includes a plurality of metallic elements, and among the metallic elements, iron (Fe) is the highest in weight ratio. Accordingly, with the high frequency magnetic material including the magnetic particle 50 undergoing the hydrophobic treatment, the magnetic permeability (the real part Re(μ) of the complex magnetic permeability) can be increased.

Furthermore, the particle diameter d of the magnetic particle 50 is 45 nm or less. In addition, the thickness t of the coating film 52 is 1 nm to 10 nm. Accordingly, with the high frequency magnetic material including the magnetic particle 50 undergoing the hydrophobic treatment, oxidation and ignition in the mixing process can be prevented, the magnetic loss can be reduced, and excellent reproducibility can be obtained. It is preferable that the thickness t be 3 nm to 6 nm.

Furthermore, the filling rate of the magnetic particle 50 in the high frequency magnetic material is 1 vol % to 60 vol %. Accordingly, with the high frequency magnetic material including the magnetic particle 50 undergoing the hydrophobic treatment, the magnetic permeability (the real part Re(μ) of the complex magnetic permeability) can be increased, the mixability and the moldability can be improved, and the energy loss caused by the magnetic loss can be reduced, so that the product characteristics can be improved.

The high frequency device is an antenna, an inductor or a circuit substrate to which the high frequency magnetic material including the magnetic particle 50 undergoing the hydrophobic treatment is applied. Accordingly, with the high frequency device, the magnetic loss and the dielectric loss can be reduced. When the high frequency device is an antenna, by applying the high frequency magnetic material having low magnetic loss and low dielectric loss to the antenna, radiation efficiency of the antenna can be increased, and the device can be miniaturized. When the high frequency device is an inductor, by applying the high frequency magnetic material in the embodiment to the inductor, the inductance value (L) can be made high. When the high frequency device is a circuit substrate, although the circuit layout of a distributed constant circuit which is often used for a high frequency circuit is designed by taking a ¼ wavelength of a signal as a base unit, by applying the high frequency magnetic material in the embodiment to the circuit substrate, the propagation wavelength of a signal is shortened by the wavelength shortening effect. Consequently, the physical length of a wiring can be shortened, and accordingly, the circuit substrate can be miniaturized.

The embodiment described above is an example of the magnetic particle, the high frequency magnetic material and the high frequency device of the present invention. Hence, the present invention is not limited thereto.

In the embodiment, the coating film 52 is magnetite Fe₃O₄ as an oxide, but not limited thereto. The coating film 52 may be another oxide, a nitride, a carbide or a fluoride. As another oxide, there are Al₂O₃, BeO, CeO₂, Cr₂O₃, HfO₂, MgO, SiO₂, ThO₂, TiO₂, UO₂, ZrO₂, CrO₂, MnO₂, MoO₂, NbO₂, OsO₂, PtO₂, ReO₂(β), Ti₂O₃, Ti₃O₅, Ti₄O₇, Ti₅O₉, WO₂, V₂O₃, V₄O₇, V₅O₉, V₆O₁₁, V₇O₁₃, V₈O₁₅, VO₂ and V₆O₁₃. As the nitride, there are BN, NbN, Ta₂N and VN. As the carbide, there are HfC, MoC, NbC, SiC(β), TiC, UC, VC, WC and ZrC. As the fluoride, there are AlF₃, BaF₂, BiF₃, CaF₂, CeF₃, DyF₂, GdF₃, HoF₃, LaF₃, LiF, MgF₂, NaF, Na₃AlF₆, Na₅A₁₃F₁₄, NdF₃, PbF₂, SrF₂, ThF₄, YF₃ and YbF₃. Although the coating film 52 needs high specific resistance in order to reduce the eddy current loss and the dielectric loss, the coating film 52 is not always necessary to be insulating, depending on the frequency used in the high frequency device or an application form.

Furthermore, in the embodiment, as the thermoplastic resin to be combined with the magnetic particle 50, polypropylene (PP) or cycloolefin polymer (COP) is used. However, this is not a limit. As the thermoplastic resin, for example, polyethylene (PE), polystyrene (PS), polymethyl methacrylate (PMMA), vinyl chloride, nylon (PA), polycarbonate (PC), polyacetal (POM), polybutylene terephthalate (PBT), polyethylene terephthalate (PET) or modified polyphenylene ether (modified PPE) may be used.

Furthermore, the mixing device which mixes the magnetic particle 50 undergoing the hydrophobic treatment with the thermoplastic resin is not limited to a twin screw extruder. As the mixing device, an extruder other than a twin screw extruder, a kneader, a bead mill or the like may be used.

Furthermore, the molding method of the high frequency magnetic material is not limited to extrusion molding using an extruder. As the molding method, injection molding, compression molding or the like may be used.

Furthermore, the detailed structures and operations of the magnetic particle, the high frequency magnetic material and the high frequency device in the embodiment can be appropriately modified without departing from the scope of the present invention.

According to a first aspect of the embodiment of the present invention, there is provided a magnetic particle including: a metallic magnetic; and a coating film including an oxide, a nitride, a carbide or a fluoride, the coating film covering the metallic magnetic, wherein hydrophobic treatment using a hydrophobing agent is carried out on the magnetic particle.

Preferably, in the magnetic particle, a hydrophobization degree is 50% or more.

Preferably, in the magnetic particle, the metallic magnetic includes a plurality of metallic elements, and among the metallic elements, iron is highest in weight ratio.

Preferably, in the magnetic particle, a particle diameter of the magnetic particle is 45 nm or less.

Preferably, in the magnetic particle, a thickness of the coating film is 1 nm to 10 nm.

According to a second aspect of the embodiment of the present invention, there is provided a high frequency magnetic material including: the magnetic particle; and thermoplastic resin combined with the magnetic particle.

Preferably, in the high frequency magnetic material, a filling rate of the magnetic particle in the high frequency magnetic material is 1 vol % to 60 vol %.

According to a third aspect of the embodiment of the present invention, there is provided a high frequency device including: at least one of an antenna, an inductor and a circuit substrate, each of which includes the high frequency magnetic material.

According to the embodiment of the present invention, the magnetic loss and the dielectric loss can be reduced.

This application is based upon and claims the benefit of priority under 35 USC 119 of Japanese Patent Application No. 2011-096997 filed on Apr. 25, 2011, the entire disclosure of which, including the description, claims, drawings, and abstract, is incorporated herein by reference in its entirety.

What is claimed is:

1. A magnetic particle comprising:
a metallic magnetic; and
a coating film including an oxide, a nitride, a carbide or a fluoride, the coating film covering the metallic magnetic, wherein
hydrophobic treatment using a hydrophobing agent is carried out on the magnetic particle.

2. The magnetic particle according to claim 1, wherein a hydrophobization degree is 50% or more.

3. The magnetic particle according to claim 1, wherein
the metallic magnetic includes a plurality of metallic elements, and
among the metallic elements, iron is highest in weight ratio.

4. The magnetic particle according to claim 1, wherein a particle diameter of the magnetic particle is 45 nm or less.

5. The magnetic particle according to claim 1, wherein a thickness of the coating film is 1 nm to 10 nm.

6. A high frequency magnetic material comprising:
the magnetic particle according to claim 1; and
thermoplastic resin combined with the magnetic particle.

7. The high frequency magnetic material according to claim 6, wherein a filling rate of the magnetic particle in the high frequency magnetic material is 1 vol % to 60 vol %.

8. A high frequency device comprising:
at least one of an antenna, an inductor and a circuit substrate, each of which includes the high frequency magnetic material according to claim 6.
